(19) United States
(12) Patent Application Publication
(10) Pub. No.: US 2026/0351953 A1
(43) Pub. Date: Nov. 5, 2026

(54) SYSTEM AND METHOD FOR PROTECTING COMPONENTS IN AN ENCLOSURE

(71) Applicant: Caterpillar Inc., Peoria, IL (US)

(72) Inventors: Luvkush Kumar, Bangalore (IN); Vishnuraj Kantharaju, Kaveripattinam (IN); Robert Allen Hamann, Tucson, AZ (US)

(73) Assignee: Caterpillar Inc., Peoria, IL (US)

(21) Appl. No.: 19/196,806

(22) Filed: May 2, 2025

(51) Int. Cl. H02H 6/00; G01J 5/00; H04N 23/23; H04N 23/54

(52) U.S. Cl. CPC H02H 6/005; G01J 5/0096; H04N 23/23; H04N 23/54

(57) ABSTRACT

A system, for protecting components accommodated in an enclosure associated with an electrical system, includes an imaging device, a first actuator and second actuators to facilitate translational movement and rotational movement, respectively, of the imaging device, and a controller configured to: determine an active load associated with the electrical system; identify, based on the determined active load, at least one active component; selectively actuate the first and second actuators to position the imaging device within the enclosure to capture a digital image of the at least one active component; process the digital image to determine operating data of the at least one active component; detect a fault condition of the at least one active component based on the operating data; and generate, in response to the detected fault condition, at least one output to prevent failure of the at least one active component and remaining components within the enclosure.

### TECHNICAL FIELD

The present disclosure relates to enclosures for systems or machines. More particularly, the present disclosure relates to a system and a method for protecting components housed within an enclosure, for example, a switchgear cabinet.

### BACKGROUND

Systems, or machines, may include multiple components for serving various applications of the systems or machines. Examples of such components may include, but not limited to, electrical components, electromechanical components, hydromechanical components, electrohydraulic components. In an example, a typical electrical machine, or standalone device such as switchgear, may include components, such as circuit breakers, contactors, and fuses that may be disposed in electrical connection, for example, between an electrical power source, for example, a battery pack, and one or more electrically powered devices, for example, electric motors of the machine.

These components are generally housed within an electrical cabinet of the machine so that they can be protected from elements of an external environment, e.g., debris, dirt, dust, and moisture. In operation, these components may release heat which may result in an increase in temperature within an interior volume of the electrical cabinet, thus making the components susceptible to failure or malfunction, e.g., arcing, or shorting. In such scenarios, these components may present a serious hazard to personnel and property if left unmonitored.

U.S. Pat. No. 11,832,025, hereinafter referred to as “U.S. Patent '025”, discloses systems and methods for measuring, assessing, predicting, improving and presenting the state of physical object and human core temperatures, using imaging devices, e.g., a thermal infrared camera, and/or intruders in a region of interest to an operator, such that little or no operator effort is required to install, use or receive reports from the system. The U.S. Patent '025 further discloses means and methods for exploiting autonomous operation and configuration, placement at remote sites, enhancement of image resolution and estimation of range such that accuracy of results and autonomy of operation is enhanced.

### SUMMARY OF THE INVENTION

In one aspect, the disclosure relates to a system for protecting a plurality of components accommodated in an enclosure associated with an electrical system. The system includes an imaging device, a first actuator, a second actuator, and a controller. The imaging device is configured to capture digital images of the plurality of components. The first actuator is configured to facilitate translational movement of the imaging device in a longitudinal direction along an interior of a wall of the enclosure. The second actuator is configured to facilitate rotational movement of the imaging device about an axis parallel to the longitudinal direction. The controller is in communication with the imaging device, the first actuator, and the second actuator. The controller is configured to: determine an active load of a plurality of loads associated with the electrical system; identify, based on the determined active load, at least one active component from the plurality of components; selectively actuate the first actuator and the second actuator to position the imaging device within the enclosure to capture a digital image of the at least one active component; process the digital image of the at least one active component to determine operating data of the at least one active component; detect a fault condition of the at least one active component based on the operating data; and generate, in response to the detected fault condition, at least one output to prevent failure of the at least one active component and remaining components of the plurality of components within the enclosure.

In another aspect, the disclosure relates to a method for protecting a plurality of components accommodated in an enclosure associated with an electrical system. The method includes determining, by a controller, an active load of a plurality of loads associated with the electrical system. The method further includes identifying, by the controller, based on the active electrical load, at least one active component from the plurality of components. Further, the method includes selectively actuating, by the controller, a first actuator and a second actuator to position an imaging device within the enclosure to capture a digital image of the at least one active component. Furthermore, the method includes processing, by the controller, the digital image of the at least one active component to determine operating data of the at least one active component. In addition, the method includes detecting, by the controller, a fault condition of the at least one active component based on the operating data. Moreover, the method includes generating, by the controller, in response to the fault condition, at least one output to prevent failure of the at least one active component and remaining components of the plurality of components within the enclosure.

In yet another aspect, the disclosure relates to an enclosure for an electrical system. The enclosure includes a plurality of walls enclosing a plurality of components, and a system for protecting the plurality of components. The plurality of walls includes a first wall openable with respect to other walls of the plurality of walls to provide an access to the plurality of components. The system includes a thermal imaging device, a first actuator, a second actuator, and a controller. The thermal imaging device is configured to capture thermal digital images of the plurality of components. The first actuator is configured to facilitate translational movement of the thermal imaging device in a longitudinal direction along an interior of a wall of the enclosure. The second actuator is configured to facilitate rotational movement of the thermal imaging device about an axis parallel to the longitudinal direction. The controller is in communication with the thermal imaging device, the first actuator, and the second actuator. The controller is configured to: determine an active load of a plurality of loads associated with the electrical system; identify, based on the determined active load, at least one active component from the plurality of components; selectively actuate the first actuator and the second actuator to position the thermal imaging device within the enclosure to capture a thermal digital image of the at least one active component; process the thermal digital image of the at least one active component to determine operating data of the at least one active component; detect a fault condition of the at least one active component based on the operating data; and generate, in response to the detected fault condition, at least one output to prevent failure of the at least one active component and remaining components of the plurality of components within the enclosure.

### BRIEF DESCRIPTION OF THE DRAWINGS

FIG. 1 illustrates a schematic diagram of an exemplary enclosure accommodating multiple components associated with an electrical system and a system for protecting the components, in accordance with an embodiment of the present disclosures;

FIG. 2 illustrates the system of FIG. 1, in accordance with an embodiment of the present disclosure;

FIGS. 3 and 4 illustrate top views of the exemplary enclosure, in accordance with an embodiment of the present disclosure;

FIG. 5 illustrates an imaging device, of the system of FIG. 2, capturing different zones of the exemplary enclosure, in accordance with an embodiment of the present disclosure; and

FIG. 6 is a flowchart illustrating a method for protecting the components, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

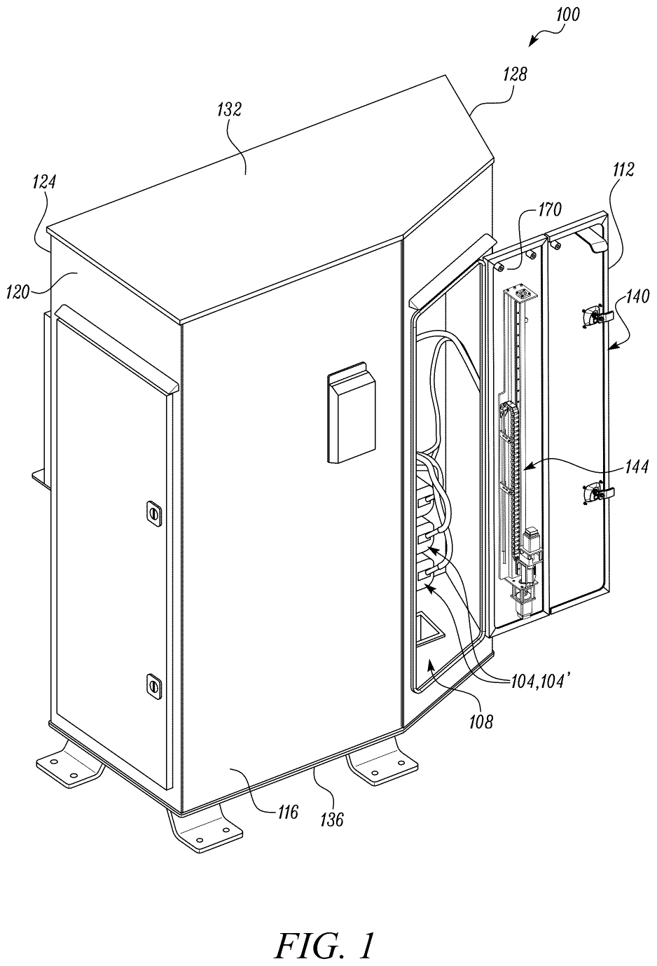

Referring to FIG. 1, an exemplary enclosure 100 is shown. The enclosure 100 may be configured to accommodate components 104 to protect the components 104 from outside environmental factors such as moisture, dirt, debris, and dust. Examples of the components 104 may include, but not limited to: electrical components such as fuses, circuit breakers, resistors, capacitors, inductors, contactors, transformers, printed circuit boards (PCBs), semiconductor devices such as diodes and transistors, integrated circuits (ICs), microcontrollers, digital signal processors (DSPs), voltage sensors, current sensors, and power supplies; mechanical components such as hoses for directing coolant through the other components within the enclosure 100, supporting structures for mounting devices within the enclosure 100, and mechanical linkages; electromechanical components such as electric motors, solenoids, relays, actuators, and servo motors; hydromechanical components such as hydraulic cylinders, pistons, accumulators, check valves, flow restrictors, and mechanical linkages coupled to hydraulic actuators; and electrohydraulic components such as electrohydraulic valves, solenoid-operated directional control valves, and electronically controlled hydraulic pumps.

In an example, the enclosure 100 may be associated with an electrical system, for example, an electrical device, or an electrically powered machine, not shown, and the components 104 may be electrical components 104′ associated with loads, not shown, of the electrical system. Examples of the electrical components 104′ may include, but not be limited to, at least one of electrical fuses, electrical contactors, and circuit breakers. It should be noted that the electrical components 104′ may also include other power electronic devices, or components, or circuits, such as retarders, resistor grids, switches, communication buses, and controllers.

The enclosure 100 defines an internal volume 108 for accommodating the components 104. In an exemplary embodiment, as shown in FIGS. 1, 4, and 5, the enclosure 100 includes walls—a first wall 112, a second wall 116, a third wall 120, a fourth wall 124, a fifth wall 128, a sixth wall or top wall 132, and a seventh wall or bottom wall 136. The sixth wall 132 and the seventh wall 136 may be substantially parallel to and spaced apart from one another. The first wall 112, the second wall 116, the third wall 120, the fourth wall 124, and the fifth wall 128 may extend at an angle, for example, substantially perpendicular, with respect to the sixth wall 132 and the seventh wall 136. The second wall 116 and the fourth wall 124 may be substantially parallel to each other. The third wall 120 may extend at an angle from the second wall 116 to meet the fourth wall 124. The fifth wall 128 may extend at an angle from the fourth wall 124 to meet the first wall 112. As shown in FIGS. 1, 4, and 5, the first wall 112, the second wall 116, the third wall 120, the fourth wall 124, the fifth wall 128, the sixth wall 132, and the seventh wall 136 may be coupled, for example, welded together to surround the internal volume 108 of the enclosure 100.

The first wall 112, or a portion of the first wall 112, may be openable with respect to the other walls of the enclosure 100 to provide an access to the components 104. For instance, as shown in FIG. 1, a portion 140, hereinafter referred to as “door portion 140”, may be movable, for example, pivotable, between its closed position and open position to restrict and allow, respectively, access into the internal volume 108 of the enclosure 100. It should be contemplated that, in other embodiments, any suitable wall of the enclosure 100 may be openable with respect to the other walls.

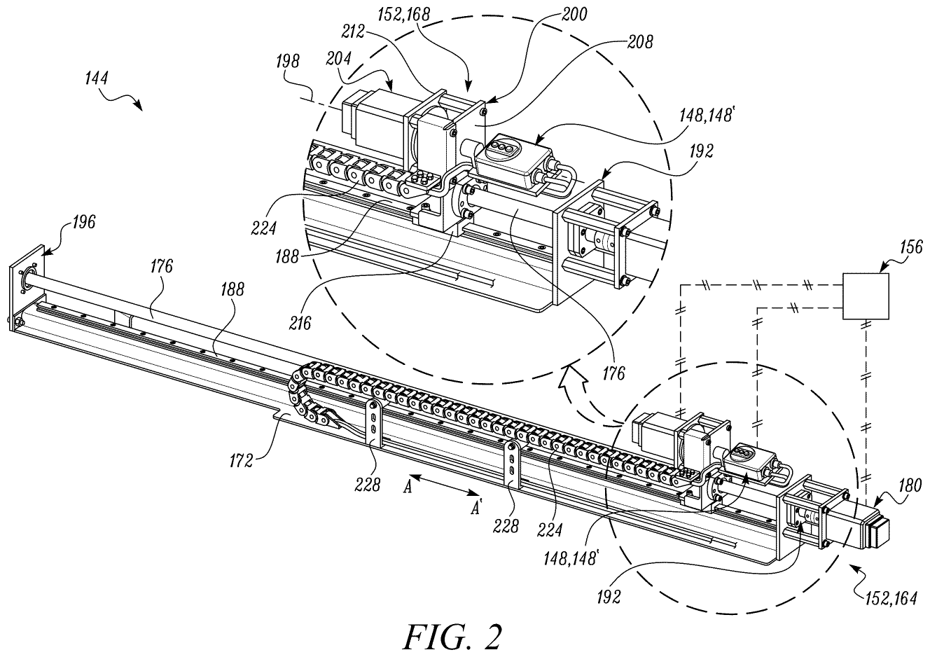

In operation, one or more of these components 104 may release heat which may result in an increase in temperature inside the enclosure 100, thus making the components 104 susceptible to failure or malfunction e.g., arcing, or shorting. To monitor and protect the components 104 accommodating within the enclosure 100, in one or more aspects of the present disclosure, a system 144 is disclosed. The system 144 includes an imaging device 148, at least one actuator 152, and a controller 156, as shown in FIG. 2.

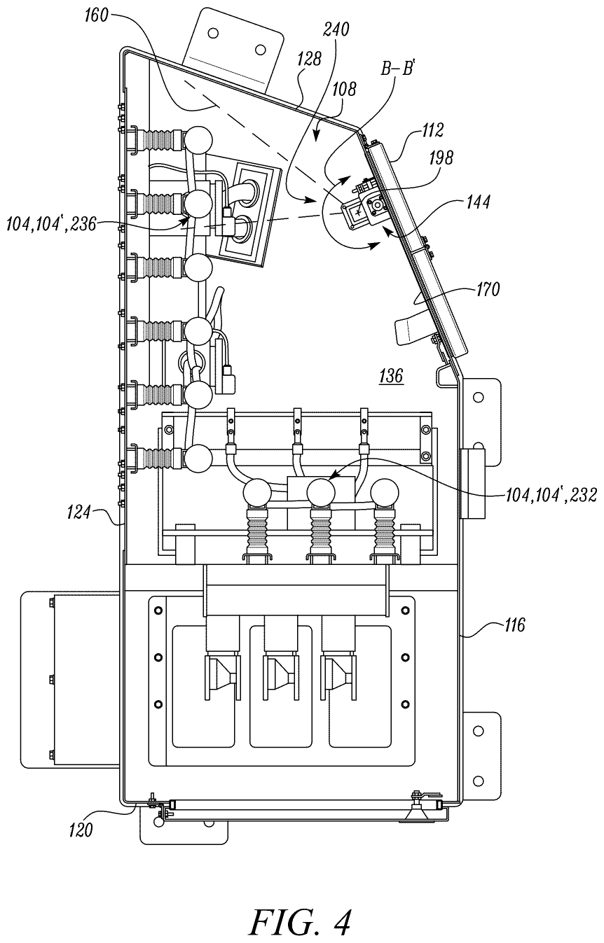

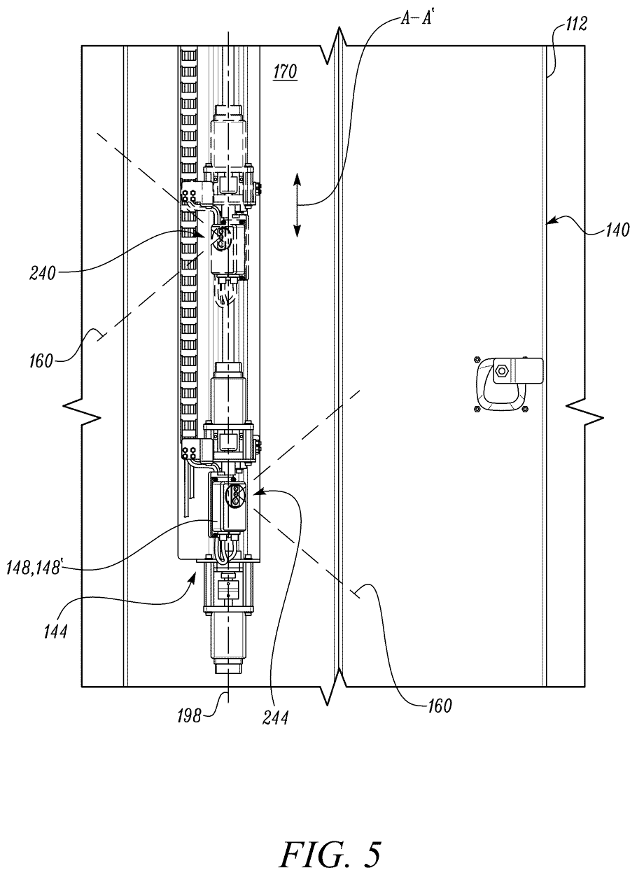

The imaging device 148 may be any image sensing device known in the art having a defined field of view 160, as shown in FIGS. 4 and 5. As used throughout this disclosure, the term “field of view” refers to a total area that the imaging device 148 is capable of capturing in three dimensions as a digital image. In an embodiment, the field of view may be a horizontal field of view. In an exemplary embodiment, as shown in FIGS. 1-6, the imaging device 148 is a thermal imaging device 148′ configured to detect infrared electromagnetic radiation emitted from the components 104 that lie within the field of view 160 of the thermal imaging device 148′.

In an example, the thermal imaging device 148′ may be ratio, or dual colored, or multi-colored pyrometers configured to monitor intensity of radiation emitted at multiple wavelengths from the components 104. The thermal imaging device 148′ enables non-contact temperature measurements on the components 104. Although not specifically shown, the thermal imaging device 148′ may include a scanning and detecting device that is sensitive to predefined wavelengths appropriate for temperatures achieved because of operations of the components 104. In an embodiment, the thermal imaging device 148′ may be configured to capture a thermal digital image, or thermal signature, associated with the components 104 contained within the field of view 160. The thermal digital image, or thermal signature, as captured by the thermal imaging device 148′ may be indicative of thermal gradients in the components 104. It should be noted that the design of the thermal imaging device 148′ shown in the accompanying figures is exemplary and does not limit the scope of the present disclosure.

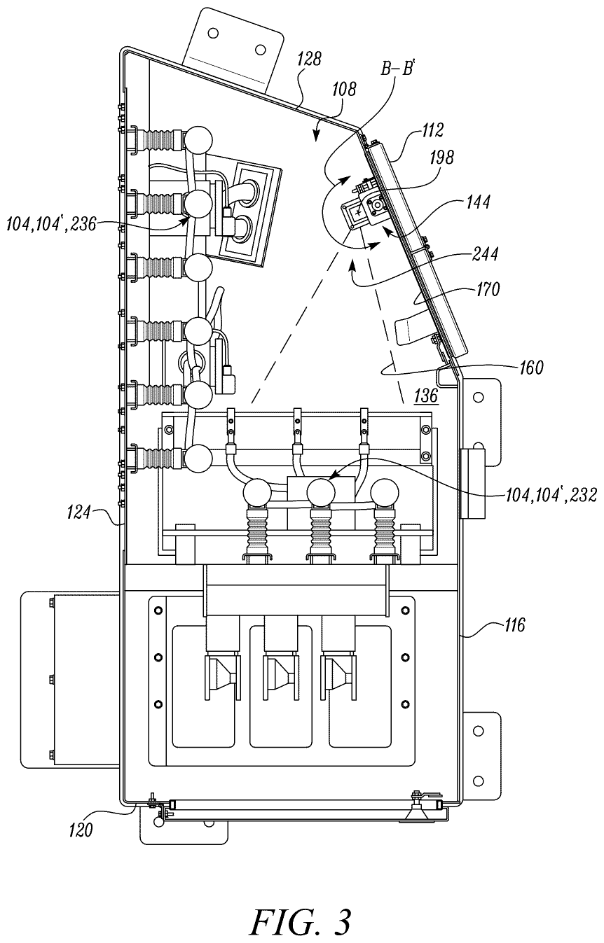

Referring to FIGS. 2 and 3, two actuators 152, namely—a first actuator 164 and a second actuator 168. The first actuator 164 is configured to facilitate translational movement of the imaging device 148, for example, in a longitudinal direction, shown via arrows A-A′, along an interior 170 of the first wall 112 of the enclosure 100. In an embodiment, the first actuator 164 includes a supporting frame structure 172, a lead screw 176, and a first motor 180. The supporting frame structure 172 may be connected to the interior 170 of the first wall 112. The supporting frame structure 172 may define a guiding rail 188 extending longitudinally along a length of the supporting frame structure 172. In addition, the supporting frame structure 172 may include bearing assemblies 192,196, mounted at opposite ends of the supporting frame structure 172. The lead screw 176 may be supported on the interior 170 of the first wall 112, for example, via the bearing assemblies 192, 196 of the supporting frame structure 172, as shown in FIG. 2. The first motor 180 may be an electrically powered motor. The first motor 180 may be operably coupled with the lead screw 176 to drive the lead screw in a manner to facilitate the translational movement of the imaging device 148, or the thermal imaging device 148′, along the longitudinal direction A-A′.

The second actuator 168 is configured to facilitate rotational movement of the imaging device 148 about an axis 198 along a direction B-B′, shown in FIGS. 3 and 4. In an embodiment, the axis 198 may be parallel to the longitudinal direction A-A′. In another embodiment, the axis 198 may be at an angle with respect to the longitudinal direction A-A′. In an embodiment, the second actuator 168 includes a mounting bracket 200 and a second motor 204. The mounting bracket 200 may define a first mounting portion 208, a second mounting portion 212, and a third mounting portion 216. The first mounting portion 208 may be configured to mount the imaging device 148, or the thermal imaging device 148′, onto the mounting bracket 200. The second mounting portion 212 may be configured to mount the second motor 204 onto the mounting bracket 200. The third mounting portion 216 may be configured to mount the mounting bracket 200 onto the guiding rail 188 of the supporting frame structure 172 of the first actuator 164. Once mounted to the guiding rail 188 of the supporting frame structure 172, the mounting bracket 200, along with the imaging device 148 and the second motor 204, may be moved along the longitudinal direction A-A′. The second motor 204 may be operably coupled with the imaging device 148 to power the rotational movement of the imaging device 148 about the axis 198 along the direction B-B′.

Additionally, in an embodiment, as shown in FIG. 2, additional supporting components, such as a chain assembly 224 and at least one guiding roller assembly 228 may be connected to the first actuator 164. The chain assembly 224 and the guiding roller assembly 228 may be configured to guide and support the movement of the second actuator 168, and the imaging device 148, along the guiding rail 188 of the supporting frame structure 172 of the first actuator 164.

The controller 156 is now discussed. The controller 156 may be an electronic controller that operates in a logical fashion to perform operations, execute control algorithms, store, and retrieve data and other desired operations. The controller 156 may include or access memory, secondary storage devices, processors, and any other components for running an application. The memory and secondary storage devices may be in the form of read-only memory, ROM, or random-access memory, RAM, or integrated circuitry that is accessible by the controller 156. Various other circuits may be associated with the controller 156 such as power supply circuitry, signal conditioning circuitry, driver circuitry, and other types of circuitry.

The controller 156 may be a single controller or may include more than one controller disposed to control various functions and/or features of the enclosure 100 or its associated system. The term “controller” is meant to be used in its broadest sense to include one or more controllers and/or microprocessors that may be associated with the enclosure 100 or its associated system, and that may cooperate in controlling various functions and operations of the enclosure 100 or its associated system. The functionality of the controller 156 may be implemented in hardware and/or software without regard to the functionality. The controller 156 may rely on one or more data maps relating to the operating conditions and the operating environment of the enclosure 100 and its system that may be stored in the memory of or associated with the controller 156. Each of these data maps may include a collection of data in the form of tables, graphs, and/or equations.

The controller 156 may be communicably coupled with loads associated with the system, for example, electrical loads associated with the electrical system. The controller 156 may be configured to receive signals indicative of the operating status, e.g., active or inactive status, of the loads, or an associated electrical device, or an associated electrically powered machine. In an example, the controller 156 may use the operating status information to enable or disable the functioning of the system 144. By way of the controller 156 communicable coupling with the loads associated with the system, the controller 156 may be configured to determine one or more active loads out of multiple loads. In addition, the controller 156 may be configured to obtain information related to operating profiles and characteristics of the loads. In an embodiment, the controller 156 may extract said information about the operating profiles and characteristics of the loads from its memory. In another embodiment, the controller 156 may be in communication with a control unit, e.g., ECU, of the electrical system to obtain operating statuses, e.g., active or inactive statuses, operating profiles, and characteristics of the loads.

Based on the determination of the one or more active loads, the controller 156 may be configured to identify at least one active component 104 out of multiple components 104. In an embodiment, the controller 156 may identify one or more active components 104 associated with said determined active load from a table prestored in the memory of the controller 156. In an example, upon determining that a propulsion motor associated with a system, or machine, is active, the controller 156 may identify a fuse 232, associated with the propulsion motor, as an active component 104. In another example, upon determining that an implement motor associated with a system, or machine, is active, the controller 156 may identify fuse 236, associated with the implement motor, as an active component 104. In addition, the controller 156 may be configured to obtain information related to operating conditions, e.g., health, of the active component 104. The controller 156 may use the operating condition information, for example, to enable or disable the functioning of the system 144. For example, in case of receipt of information indicative of an unhealthy condition of the active component 104, the controller 156 may disable the system 144 and issue a fault signal.

Further, the controller 156 is in communication with the first actuator 164 and the second actuator 168. In an embodiment, as shown in FIG. 2, the controller 156 is communicably coupled with the first motor 180 and the second motor 204. By way of the controller 156 communicable coupling with the first actuator 164 and the second actuator 168, the controller 156 may be configured to selectively actuate the first actuator 164 and the second actuator 168 to position the imaging device 148, or the thermal imaging device 148′, within the enclosure 100 to capture one or more digital images, or thermal digital images, of the components 104 enclosed within the enclosure 100. For example, the controller 156 may selectively actuate the first actuator 164 and the second actuator 168 to position the thermal imaging device 148′ to capture one or more digital images, or thermal digital images of the active components 104 within the field of view 160 of the thermal imaging device 148′.

Further, the controller 156 is in communication with the imaging device 148, e.g., the thermal imaging device 148′. By way of the controller 156 communicable coupling with the imaging device 148, the controller 156 may be configured to receive the digital image, e.g., thermal image, of the at least one active component 104 contained within the field of view 160 of the imaging device 148. The controller 156 is further configured to process the digital image to determine operating data of the at least one active component 104 captured in the digital image. In an embodiment, the operating data includes a thermal signature of the at least one active component 104. The thermal signature may be indicative of a change in thermal gradient, i.e., rise in temperature, over a defined period of time associated with the active component 104 during operation of the associated active load.

Based on the determined operating data, the controller 156 is further configured to detect a fault condition, if any, of the active component 104. To this end, the controller 156 may compare the operating data of the active component 104, determined upon processing the digital image, with a corresponding threshold value. The controller 156 may determine said threshold value based on the operating parameters of the associated active electrical load.

In an exemplary embodiment in which the operating data includes the thermal signature of the active component 104, the controller 156 may compare the thermal signature of the active component 104 with a threshold temperature and identifies if the thermal signature has exceeded the threshold temperature for a predefined time. If the thermal signature of the active component 104 exceeds the threshold temperature, for example, for a predefined time, the controller 156 identifies a fault condition of the active component 104. The fault condition of the active component 104 may be indicative of at least one of a loose connection condition, a corroded connection condition, an unbalanced electrical load condition, an overloading condition, and an overheating condition. In an example, the controller 156 may determine the threshold temperature based on the operating parameters of the associated active load. Examples of the operating parameters of the associated active load may include, but not limited to, voltage, current, speed, torque, power, and load duty.

In an embodiment, upon identifying the thermal signature of the active component 104 exceeding the threshold temperature, i.e., hotspot condition, the controller 156 may control the first actuator 164 and the second actuator 168 in a manner to stop and hold the imaging device 148 to its current location so as to capture said thermal signature of the active component 104, for example, for five to ten seconds, to confirm the occurrence of the fault condition of the component 104.

Further, in response to the detection of the fault condition, the controller 156 is configured to generate at least one output, e.g., to activate an alarm, or to electrically cut-off the components 104, so as to prevent failure of the active component 104, e.g., fuse 232, and the remaining components 104 within the enclosure 100. In an exemplary embodiment, the controller 156 may predict failure of the active component 104 and the remaining components based on the detected fault condition of the active component 104. In another exemplary embodiment, the controller 156 may perform at least one corrective action to prevent or mitigate potential hazard occurred due to the fault condition.

### INDUSTRIAL APPLICABILITY

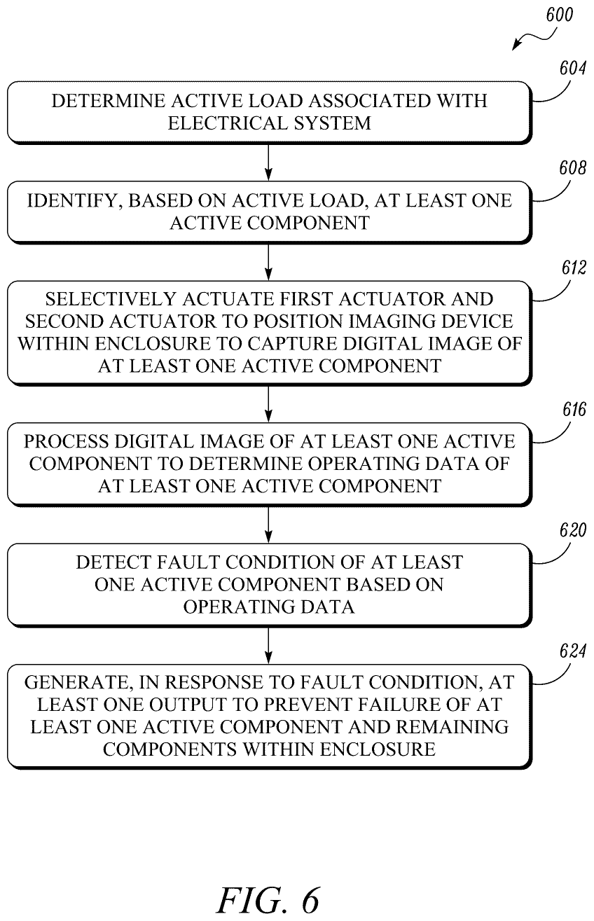

Referring to FIG. 6, an example method for protecting components accommodated in an enclosure, for example, components 104 accommodated in the enclosure 100, using the system 144 is now discussed. The method is discussed by way of a flowchart 600 that illustrates example steps, i.e., from 604 to 624, associated with the method. The example method is also discussed in conjunction with FIGS. 1 to 5. It will be appreciated that the description in the method is exemplary in nature and that the steps can be performed in different executable details than what is set out below, as will be contemplated by a person skilled in the art based on the description of the present disclosure.

At step 604, the controller 156 determines active load(s), e.g., active electrical loads, out of multiple loads associated with the electrical system. For that, the controller 156 may directly communicate with the loads to receive signals indicative of operating status, e.g., active or inactive status, from the loads. In another embodiment, the controller 156 may receive operating status of the loads from a control unit, e.g., ECU, of the electrical system. In addition, the controller 156 may obtain information related to operating profiles and characteristics of the active load(s). For example, the controller 156 may extract said information about the operating profiles and characteristics of the active load(s) from its memory. The controller 156 may receive signals indicative of operating status, e.g., active or inactive status, of the loads, or an associated electrical device, or an associated electrically powered machine, to enable or disable the functioning of the system 144.

At step 608, the controller 156 identifies at least one active component 104 based on the active load(s) determined at step 604. In an example, upon determining that a propulsion motor associated with an electrical machine is active, the controller 156 may identify the fuse 232, associated with the propulsion motor, as an active component 104. In another example, upon determining that an implement motor associated with said machine is active, the controller 156 may identify the fuse 236, associated with the implement motor, as an active component 104. In addition, the controller 156 may obtain information related to operating conditions, e.g., health, of the identified active component 104, and use said information, for example, to enable or disable the functioning of the system 144. For instance, in case of receipt of information indicative of an unhealthy condition of the component 232, the controller 156 may disable the system 144 and issue a fault signal. In some other embodiments, the controller 156 may also obtain information related to operating conditions, e.g., health, of the imaging device 148 to enable or disable the functioning of the system 144.

Upon verifying the healthy operating conditions of the loads, the components 104, and the imaging device 148, the controller 156, at step 612, actuates at least one of the first actuator 164 and the second actuator 168 to position the imaging device 148, or the thermal imaging device 148′, within the enclosure 100 to clearly capture one or more digital images, or thermal digital images, of the active component(s) 104, identified at step 608, within the field of view 160 of the imaging device 148. For example, upon identifying the fuse 236 associated with the implement motor as an active component 104, the controller 156 may actuate the first motor 180 to move the imaging device 148 along the longitudinal direction A-A′, and the second motor 204 to rotate the imaging device 148 along the direction B-B′ about the axis 198, to position the imaging device 148 at a location 240 from where a clear image or video feeds of the fuse 236 and its surrounding components 104 may be captured from the imaging device 148, as shown in FIGS. 4 and 5.

In another example, upon identifying the fuse 232 associated with the propulsion motor, as an active component 104, the controller 156 may actuate the first motor 180 to move the imaging device 148 along the longitudinal direction A-A′, and the second motor 204 to rotate the imaging device 148 along the direction B-B′ about the axis 198, to position the imaging device 148 at a location 244 from where a clear image or video feeds of the fuse 232 and its surrounding components 104 may be captured from the imaging device 148, as shown in FIGS. 3 and 5.

The controller 156 receives the digital image, e.g., thermal image, of the active component(s) 104 captured and contained within the field of view 160 of the imaging device 148 at step 612. Upon receipt of the digital image, the controller 156, at step 616, processes the digital image to determine the operating data, for example, thermal signature indicative of a change in thermal gradient over a defined period associated with the active component(s) 104.

Based on the determined operating data, i.e., thermal signature, the controller 156, at step 620, detects a fault condition of the active component(s) 104. In an example, the controller 156 may compare the thermal signature of the identified active component 104 with a corresponding threshold temperature and identifies if the thermal signature has exceeded its threshold temperature. If the thermal signature of the active component 104 exceeds the threshold temperature, indicating a hotspot, for a predefined time, the controller 156 identifies a fault condition, for example, a loose connection, of the active component 104. The threshold temperature may be determined based on the operating parameters, such as voltage, current, speed, torque, power, and load duty, of the associated active load. In an example, upon identifying the thermal signature of the component 104 exceeding the threshold temperature, the controller 156 may control the first actuator 164 and the second actuator 168 in a manner to stop and hold the imaging device 148 to its current location so as to capture said thermal signature of the component 104, for example, for five to ten seconds, to confirm the occurrence of the fault condition of the component 104. In case of identification of no hotspots, the controller 156 may continue to selectively control the actuation of the first actuator 164 and the second actuator 168 to keep repeating the scan cycle until the conditions are healthy or the system 144 gets disabled.

Further, in response to the detection of the fault condition, the controller 156, at step 624, generates at least one output to prevent failure of the active component 104, e.g., fuse 232, or the fuse 236, and the remaining components 104 within the enclosure 100. In an example, the controller 156 may provide a notification to an operator indicative of the fault condition of the component 104, for example, via an audio or visual notification, such as an alarm. In another example, the controller 156 may output a command signal to cut-off or trip the corresponding active load e.g., the propulsion motor associated with the fuse 232, or the implement motor associated with the fuse 236. In yet another example, upon detection of such fault condition, the controller 156 may activate hazard control systems, e.g., a fire extinguishing system, to prevent any failure of the components 104 and the enclosure 100 and avoid any potential hazard due to failure of the components 104.

The system 144 facilitates monitoring the operating parameters, e.g., thermal signatures, of the components 104 accommodated within the enclosure 100 to detect fault conditions, e.g., thermal hotspots, of the components 104. For example, the system 144 may detect components 104 under the load that exhibit the thermal signatures above all the other components 104. Accordingly, the system 144 may allow for early component preventative maintenance, and further prevent machine, or electrical system, shutdown conditions due to component failure. The early component fault detection or prediction would allow for a simple and cost-effective solution to fix the fault condition, like replacing the existing faulty component with a new component, or plan inventory beforehand, or appropriately connecting the component, or get the machine, or the electrical system, serviced before significant damage to the components, the enclosure 100 accommodating the components, and the associated electrical machine or system. Further the system 144 described herein is a simple configurable system that can be easily retrofitted on existing enclosures, such as the enclosure 100, without major modifications and cost inclusions.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C.

It will be apparent to those skilled in the art that various modifications and variations can be made to the system, the method, and/or the enclosure of the present disclosure without departing from the scope of the disclosure. Other embodiments will be apparent to those skilled in the art from consideration of the specification and practice of the system, the method, and/or the enclosure disclosed herein. It is intended that the specification and examples be considered as exemplary only, with a true scope of the disclosure being indicated by the following claims and their equivalent.

What is claimed is:

1. A system for protecting a plurality of components accommodated in an enclosure associated with an electrical system, the system comprising:
an imaging device to capture digital images of the plurality of components;
a first actuator configured to facilitate translational movement of the imaging device in a longitudinal direction along an interior of a wall of the enclosure;
a second actuator configured to facilitate rotational movement of the imaging device about an axis; and
a controller in communication with the imaging device, the first actuator, and the second actuator, the controller is configured to:
determine an active load of a plurality of loads associated with the electrical system;
identify, based on the determined active load, at least one active component from the plurality of components;
selectively actuate the first actuator and the second actuator to position the imaging device within the enclosure to capture a digital image of the at least one active component;
process the digital image of the at least one active component to determine operating data of the at least one active component;
detect a fault condition of the at least one active component based on the operating data; and
generate, in response to the detected fault condition, at least one output to prevent failure of the at least one active component and remaining components of the plurality of components within the enclosure.

2. The system of claim 1, wherein the operating data includes a thermal signature of the at least one active component, and wherein the controller detects the fault condition when the thermal signature of the at least one active component exceeds a threshold temperature for a predefined time.

3. The system of claim 2, wherein the controller determines the threshold temperature of the at least one active component based on operating parameters of the active load associated with the at least one active component.

4. The system of claim 3, wherein the operating parameters of the active load includes at least one of voltage, current, speed, torque, power, and load duty.

5. The system of claim 1, wherein the imaging device is a thermal imaging device configured to capture thermal images of the of the plurality of components accommodated within the enclosure.

6. The system of claim 1, wherein the first actuator includes a lead screw supported on the interior of the wall of the enclosure, and a first motor operably coupled with the lead screw to power the translational movement of the imaging device, and
wherein the second actuator includes a mounting bracket operably coupled with the lead screw and configured to mount the imaging device thereon, and a second motor supported on the mounted bracket and operably coupled with the imaging device to power the rotational movement of the imaging device.

7. The system of claim 1, wherein the fault condition includes at least one of a loose connection condition, a corroded connection condition, an unbalanced electrical load condition, an overloading condition, and an overheating condition.

8. The system of claim 1, wherein the plurality of components includes at least one of electrical fuses, electrical contactors, and circuit breakers.

9. The system of claim 1, wherein the at least one output include:
failure prediction of the at least one active component and the remaining components of the plurality of components based on the fault condition;
performing at least one corrective action to prevent or mitigate potential hazard occurred due to the fault condition.

10. A method for protecting a plurality of components accommodated in an enclosure associated with an electrical system, the method comprising:
determining, by a controller, an active load of a plurality of loads associated with the electrical system;
identifying, by the controller, based on the active load, at least one active component from the plurality of components;
selectively actuating, by the controller, a first actuator and a second actuator to position an imaging device within the enclosure to capture a digital image of the at least one active component;
processing, by the controller, the digital image of the at least one active component to determine operating data of the at least one active component;
detecting, by the controller, a fault condition of the at least one active component based on the operating data; and
generating, by the controller, in response to the fault condition, at least one output to prevent failure of the at least one active component and remaining components of the plurality of components within the enclosure.

11. The method of claim 10, wherein the operating data includes a thermal signature of the at least one active component, and wherein the controller detects the fault condition when the thermal signature of the at least one active component exceeds a threshold temperature for a predefined time.

12. The method of claim 11, wherein the threshold temperature range of the at least one active component is determined based on operating parameters of the active load associated with the at least one active component.

13. The method of claim 12, wherein the operating parameters of the active load includes at least one of voltage, current, speed, torque, power, and load duty.

14. The method of claim 10, wherein the imaging device is a thermal imaging device configured to capture thermal digital images of the of the plurality of components accommodated within the enclosure.

15. The method of claim 10, wherein the first actuator includes a lead screw supported on an interior of a wall of the enclosure, and a first motor operably coupled with the lead screw to power a translational movement of the imaging device in a longitudinal direction along the interior, and
wherein the second actuator includes a mounting bracket operably coupled with the lead screw and configured to mount the imaging device thereon, and a second motor supported on the mounted bracket and operably coupled with the imaging device to power the rotational movement of the imaging device about an axis parallel to the longitudinal direction.

16. The method of claim 10, wherein the fault condition includes at least one of a loose connection condition, a corroded connection condition, an unbalanced electrical load condition, an overloading condition, and an overheating condition.

17. The method of claim 10, wherein the at least one output include:
failure prediction of the at least one active component and the remaining components of the plurality of components based on the fault condition;
performing at least one corrective action to prevent or mitigate potential hazard occurred due to the electrical fault condition.

18. An enclosure for an electrical system, the enclosure comprising:
a plurality of walls enclosing a plurality of components, the plurality of walls including a first wall openable with respect to other walls of the plurality of walls to provide an access to the plurality of components; and
a system for protecting the plurality of components, the system including:
a thermal imaging device to capture thermal digital images of the plurality of components;
a first actuator configured to facilitate translational movement of the thermal imaging device in a longitudinal direction along an interior of the first wall;
a second actuator configured to facilitate rotational movement of the thermal imaging device about an axis; and
a controller in communication with the thermal imaging device, the first actuator, and the second actuator, the controller is configured to:
determine an active load of a plurality of loads associated with the electrical system;
identify, based on the determined active load, at least one active component from the plurality of components;
selectively actuate the first actuator and the second actuator to position the imaging device within the enclosure to capture a digital image of the at least one active component;
process the digital image of the at least one active component to determine operating data of the at least one active component;
detect a fault condition of the at least one active component based on the operating data; and
generate, in response to the detected fault condition, at least one output to prevent failure of the at least one active component and remaining components of the plurality of components within the enclosure.

19. The enclosure of claim 18, wherein the first actuator includes a lead screw supported on the interior of the first wall of the enclosure, and a first motor operably coupled with the lead screw to power the translational movement of the thermal imaging device, and
wherein the second actuator includes a mounting bracket operably coupled with the lead screw and configured to mount the thermal imaging device thereon, and a second motor supported on the mounted bracket and operably coupled with the thermal imaging device to power the rotational movement of the thermal imaging device.

20. The enclosure of claim 18, wherein the operating data includes a thermal signature of the at least one active component,
wherein the controller detects the fault condition when the thermal signature of the at least one active component exceeds a threshold temperature for a predefined time, and
wherein the controller determines the threshold temperature of the at least one active component based on operating parameters of the active load associated with the at least one active component.
